(19) United States
(12) Patent Application Publication
(10) Pub. No.: US 2015/0253073 A1
(43) Pub. Date: Sep. 10, 2015

(54) RE-LIQUEFYING METHOD FOR STORED LIQUID

(71) Applicant: KOREA GAS CORPORATION, Gyeonggi-do (KR)

(72) Inventors: Sang Gyu Lee, Seoul (KR); Yeong Beom Lee, Seoul (KR); Kyu Sang Cha, Incheon (KR); Young Soon Sohn, Incheon (KR); Kun Hyung Choe, Seoul (KR); Dong-Hyuk Kim, Incheon (KR)

(21) Appl. No.: 14/431,743

(22) PCT Filed: Oct. 22, 2013
(86) PCT No.: PCT/KR2013/009422

§ 371 Date: Mar. 26, 2015

(30) Foreign Application Priority Data
Oct. 30, 2012 (KR) 10-2012-0121442

(51) Int. Cl. F25J 1/00; F25J 1/02; F17C 9/02

(52) U.S. Cl. CPC F25J 1/0025; F17C 9/02; F25J 1/005; F25J 1/0204

(57) ABSTRACT

Provided is a re-liquefying method for a stored liquid which has a simple structure or operation and excellent process efficiency. Since the method does not use separate refrigerant, the structure or operation in the re-liquefying method is significantly simplified. In addition, since a portion of a main stream is separated to form a cycle similar to a refrigerant cycle which cools the mainstream, the process efficiency of the re-liquefying method is significantly improved.

The above Abstract is a more accurate literal translation of the abstract from the original priority application than the PCT abstract.

### CROSS-REFERENCE TO RELATED APPLICATIONS

This application claims the priority of Korean Patent Application No. 10-2012-0121442 filed on Oct. 30, 2012, in the Korean Intellectual Property Office, the disclosure of which is incorporated herein by reference.

### TECHNICAL FIELD

The present invention relates to a re-liquefying method for a stored liquid, and more particularly, to a re-liquefying method for a stored liquid which has a simple structure or operation and excellent process efficiency.

### BACKGROUND ART

Gases such as natural gas or carbon dioxide may be liquefied and stored in a storage tank in order to deliver the gases to a desired location, e.g., by a carrying vessel. During such delivery, a portion of a stored gas such as liquefied natural gas or liquefied carbon dioxide may be evaporated, e.g., by external heat to generate boil-off gas (BOG). BOG may be directly discharged to the outside. However, such direct discharge of BOG is economically or environmentally undesired. Thus, technologies of re-liquefying BOG to be re-introduced into a storage tank by using predetermined re-liquefying methods are being variously researched.

However, re-liquefying devices for re-liquefying BOG are additional parts of storage tanks. Thus, simplicity in structure or operation is a main issue in re-liquefying methods while process efficiency is a main issue in typical liquefying methods. However, since recently researched re-liquefying methods use separate refrigerant, the structure or operation thereof is complicated. In addition, when the structure or operation of re-liquefying methods is simplified, the efficiency of the re-liquefying methods is decreased.

### SUMMARY OF THE INVENTION

Accordingly, the present invention aims at providing a re-liquefying method for a stored liquid which has a simple structure or operation and excellent process efficiency

According to an aspect of the present invention, there is provided a re-liquefying method for a liquid liquefied from a vapor, in which a main stream evaporated from a storage tank storing the liquid is re-liquefied, the method including: a first introduction operation in which the main stream is introduced into a first heat exchange region; a first compression operation in which the main stream is compressed after the first introduction operation; a second introduction operation in which the main stream is introduced into a second heat exchange region after the first compression operation; a third introduction operation in which the main stream is re-introduced into the first heat exchange region after the second introduction operation; a first separation operation in which the main stream is separated into a first sub stream as a vapor and a second sub stream as a liquid after the third introduction operation; a fourth introduction operation in which the first sub stream is introduced into the first heat exchange region; a second separation operation in which the second sub stream is separated into a third sub stream and a fourth sub stream; a first cooling operation in which the main stream is cooled in the second heat exchange region by using the third sub stream; and a storage operation in which at least one portion of the fourth sub stream is stored in the storage tank.

A re-liquefying method for a stored liquid according to the present invention does not use separate refrigerant. Thus, the structure or operation in the re-liquefying method is significantly simplified. In addition, since a portion of a main stream is separated to form a cycle similar to a refrigerant cycle which cools the mainstream, the process efficiency of the re-liquefying method is significantly improved.

### BRIEF DESCRIPTION OF THE DRAWINGS

FIG. 1 is a flow diagram illustrating a re-liquefying method for a stored liquid according to a first embodiment of the present invention;

FIG. 2 is a flow diagram illustrating a first modification of the re-liquefying method of FIG. 1;

FIG. 3 is a flow diagram illustrating a second modification of the re-liquefying method of FIG. 1;

FIG. 4 is a flow diagram illustrating a re-liquefying method for a stored liquid according to a second embodiment of the present invention;

FIG. 5 is a flow diagram illustrating a first modification of the re-liquefying method of FIG. 4; and

FIG. 6 is a flow diagram illustrating a second modification of the re-liquefying method of FIG. 4.

### DETAILED DESCRIPTION OF THE INVENTION

Hereinafter, exemplary embodiments of the present invention will be described in detail with reference to the accompanying drawings. However, the present invention is not limited to the following embodiments.

### Embodiment 1

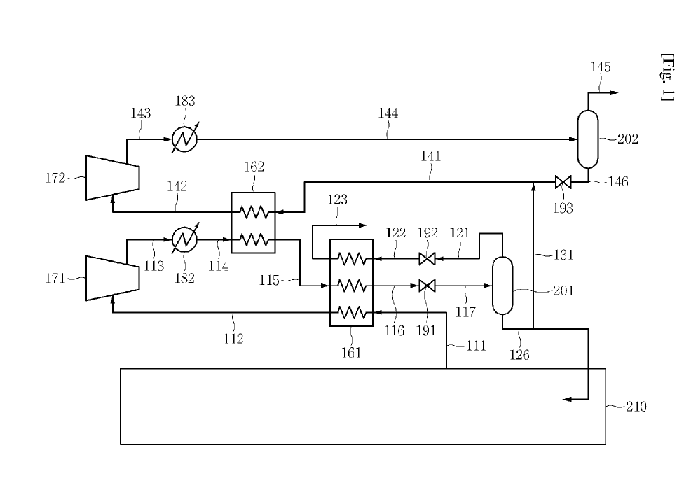

FIG. 1 is a flow diagram illustrating a re-liquefying method for a stored liquid according to a first embodiment of the present invention. A re-liquefying method according to the first embodiment is applied to a method of re-liquefying gas evaporated from a storage tank 210. A low temperature stored liquid to which such a re-liquefying method is applied may be liquefied natural gas or liquefied carbon dioxide. However, the application of the re-liquefying method is not limited to liquefied natural gas or liquefied carbon dioxide. Hereinafter, the re-liquefying method will now be described in more detail with reference to FIG. 1.

A main stream evaporated from the storage tank 210 is introduced through a conduit 111 into a first heat exchange region 161 in which heat exchange is performed (a first introduction operation). The first heat exchange region 161 may be disposed in a typical heat exchanger. A second heat exchange region, which will be described later, may also be disposed in a typical heat exchanger. The main stream introduced into the first heat exchange region 161 through the conduit 111 exchanges heat with other streams introduced into the first heat exchange region 161 through conduits 115 and 122.

After that, the main stream is introduced into a first compression member 171 through a conduit 112 and is compressed (a first compression operation). The first compression member 171 may be a typical compressor and a multi-stage compressor. Other compression members to be described later may also be a typical compressor and a multi-stage compressor. The main stream compressed as described above is introduced into a cooling member 182 through a conduit 113 and is cooled (a second cooling operation). The cooling member 182 may be a water-cooled cooler or an air-cooled cooler. A cooling member 183 to be described later may be a water-cooled cooler or an air-cooled cooler. The cooling member 182 may be removed. That is, the cooling member 182 may be used when cooling of the main stream is needed after the main stream is compressed by the first compression member 171.

After the main stream is cooled as described above, the main stream is introduced through a conduit 114 into a second heat exchange region 162 (a second introduction operation). The main stream is cooled in the second heat exchange region 162 by a third sub stream to be described later. To this end, the third sub stream forms a cooling loop to be described later. After the main stream is cooled as described above, the main stream is re-introduced through the conduit 115 into the first heat exchange region 161 (a third introduction operation). The main stream re-introduced into the first heat exchange region 161 exchanges heat with other streams in the first heat exchange region 161.

After that, the main stream is introduced into a first expansion member 191 through a conduit 116 and is expanded (a first expansion operation). Accordingly, the temperature of the main stream decreases. To this end, the first expansion member 191 may be constituted by a Joule-Thomson (J-T) valve. Other expansion members to be described later may also be constituted by a J-T valve. When a stream expands through a J-T valve, the pressure and temperature of the stream may be decreased by a J-T effect.

After the main stream is expanded as described above, the main stream is introduced through a conduit 117 into a separation member 201 and is separated into a first sub stream as a vapor and a second sub stream as a liquid (a first separation operation). The separation member 201 may be a typical vapor-liquid separator. For reference, the first expansion member 191 before the separation member 201 may be removed. That is, the first expansion member 191 may be used when a temperature decrease of the main stream is needed for vapor-liquid separation.

After the main stream is separated as described above, the first sub stream is introduced into a second expansion member 192 through a conduit 121 and is expanded (a second expansion operation). Accordingly, the temperature of the first sub stream decreases. Then, the first sub stream may cool other steams through heat exchange in the first heat exchange region 161. To this end, after being expanded, the first sub stream is introduced into the first heat exchange region 161 through the conduit 122 (a fourth introduction operation). After that, the first sub stream is discharged to the outside through a conduit 123. Accordingly, a portion of impurities may be discharged to the outside. For reference, the second expansion member 192 may be removed.

The second sub stream is separated into the third sub stream and a fourth sub stream (a second separation operation). To this end, a conduit 126 is divided into two conduits (refer to a conduit 131). After the separation of the second sub stream, the fourth sub stream is recovered as a liquid into the storage tank 210 (a storage operation).

Unlike this, the third sub stream forms a cooling loop to cool the main stream in the second heat exchange region 162 (a first cooling operation). In particular, the third sub stream is introduced into the second heat exchange region 162 through a conduit 141 (a fifth introduction operation). After that, the third sub stream is introduced into a second compression member 172 through a conduit 142 and is compressed (a second compression operation). After that, the third sub stream is introduced into the cooling member 183 through a conduit 143 and is cooled (a third cooling operation).

After that, the third sub stream is introduced through a conduit 144 into a separation member 202 and is separated into a fifth sub stream as a vapor and a sixth sub stream as a liquid (a third separation operation). After that, the fifth sub stream is discharged to the outside through a conduit 145. Accordingly, a portion of impurities may be discharged to the outside. Unlike this, the sixth sub stream is introduced into a third expansion member 193 through a conduit 146 and is expanded (a third compression operation). After that, the sixth sub stream is mixed with the third sub stream to be introduced into the second heat exchange region 162 through the conduit 141 (a first mixing operation). According to the first mixing operation, the sixth sub stream as a portion of the third sub stream flows with the third sub stream. Accordingly, the third sub stream may form a cooling loop for cooling the main stream.

A re-liquefying device for re-liquefying the main stream evaporated from the storage tank 210 may be an additional part of the storage tank 210. Thus, simplicity in structure or operation is a main issue in the re-liquefying method while process efficiency is a main issue in typical liquefying methods (for example, a method of liquefying natural gas). As a result, a use of refrigerant for re-liquefying a main stream as in typical liquefying methods is inappropriate for the re-liquefying method. This is because when refrigerant is used, members for compressing, condensing, and expanding the refrigerant are provided, which complicate structure or operation in the re-liquefying method. For reference, the complicated operation complicates control of the re-liquefying method.

However, when refrigerant is not used, process efficiency is significantly decreased. Thus, the re-liquefying method needs a member for improving process efficiency without using refrigerant. To this end, the third sub stream forms a separate cooling loop. That is, although the re-liquefying method does not use separate refrigerant for forming a refrigerant cycle, the third sub stream cools the main stream in the second heat exchange region 162 by forming a cycle similar to a refrigerant cycle.

Thus, since the re-liquefying method does not use separate refrigerant, the structure or operation in the re-liquefying method is significantly simplified. In addition, since a portion of the main stream is separated to form a cycle similar to a refrigerant cycle which cools the mainstream, the process efficiency of the re-liquefying method is significantly improved. For reference, each stream may be a vapor or a liquid in each of the locations thereof according to thermodynamic characteristics of the stream.

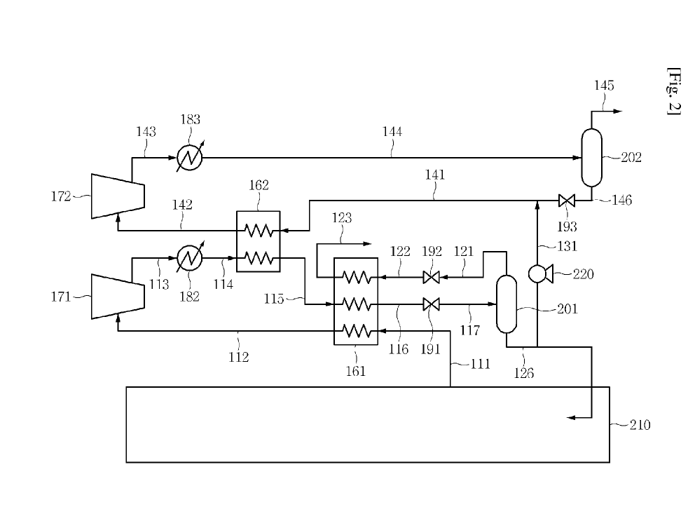

The re-liquefying method illustrated in FIG. 1 may be changed to a re-liquefying method illustrated in FIG. 2. FIG. 2 is a flow diagram illustrating a first modification of the re-liquefying method of FIG. 1. In the re-liquefying method according to the first modification, the third sub stream is forcibly transferred by a pump 220 between the second separation operation and the first cooling operation. That is, referring to FIG. 2, the third sub stream is not naturally introduced into the cooling loop and is forcibly introduced thereinto by the pump 220. In this case, a pressure of the cooling loop formed by the third sub stream is further increased, thereby increasing a re-liquefaction amount and decreasing consumed power.

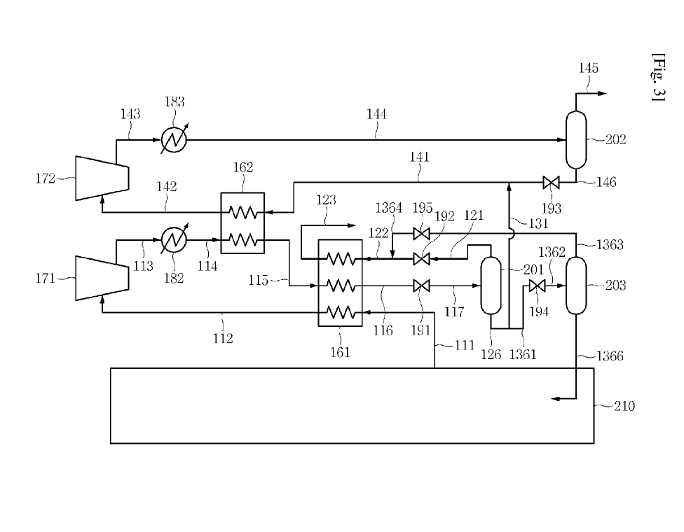

The re-liquefying method illustrated in FIG. 1 may also be changed to a re-liquefying method illustrated in FIG. 3. FIG. 3 is a flow diagram illustrating a second modification of the re-liquefying method of FIG. 1. In the re-liquefying method according to the second modification, a portion of the fourth sub stream is used for cooling the main stream, instead of just storing the fourth sub stream, thereby improving the process efficiency. In addition, a pump is not used in the re-liquefying method according to the second modification. In particular, the fourth sub stream is introduced into a fourth expansion member 194 through a conduit 1361 after the separation for the fourth sub stream and is expanded. After that, the fourth sub stream is introduced through a conduit 1362 into a separation member 203 and is separated into a seventh sub stream as a vapor and an eighth sub stream as a liquid. After that, the seventh sub stream is introduced into a fifth expansion member 195 through a conduit 1363 and is expanded. After that, when the seventh sub stream is mixed with the first sub stream to be introduced into the first heat exchange region 161 through the conduit 122. After that, the seventh sub stream and the first sub stream cool the main stream in the first heat exchange region 161. Finally, the eighth sub stream is recovered as a liquid into the storage tank 210.

The re-liquefying method according to the second modification may be an improved modification of the re-liquefying method according to the first modification. In particular, in the re-liquefying method according to the first modification as illustrated in FIG. 2, the third sub stream has the same pressure as that of the storage tank 210 before the third sub stream is forcibly transferred by the pump 220. However, in the re-liquefying method according to the second modification as illustrated in FIG. 3, the third sub stream (refer to the conduit 131) has the same pressure as a pressure (in the conduit 1361) before the fourth expansion member 194. The pressure before the fourth expansion member 194 is decreased to the pressure of the storage tank 210 by the fourth expansion member 194.

That is, the pressure of the third sub stream in the re-liquefying method according to the second modification is higher than the pressure of the third sub stream in the re-liquefying method according to the first modification. Thus, a separate pump is unnecessary in the re-liquefying method according to the second modification. Furthermore, since the re-liquefying method according to the second modification recovers cold energy through the seventh sub stream, the process efficiency thereof is higher than that of the re-liquefying method according to the first modification. Accordingly, a re-liquefaction amount in the re-liquefying method according to the second modification is greater than that in the re-liquefying method according to the first modification, and power consumed in the former is less than that in the latter.

### Embodiment 2

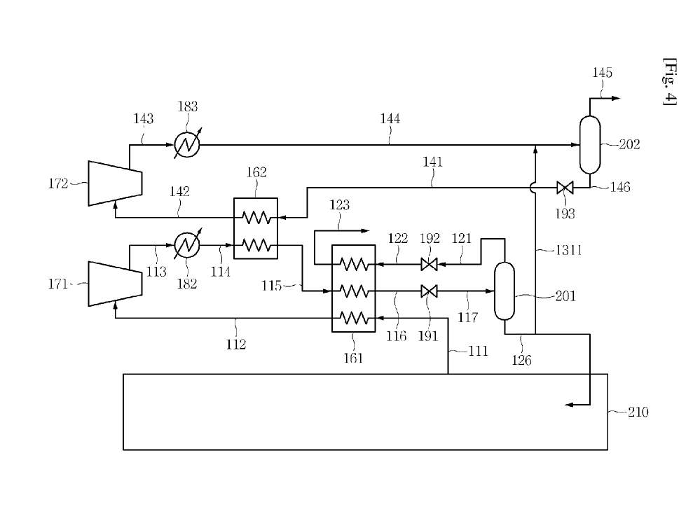

FIG. 4 is a flow diagram illustrating a re-liquefying method for a stored liquid according to a second embodiment of the present invention. Referring to FIG. 4, a re-liquefying method according to the second embodiment has a configuration that is similar to that of the re-liquefying method according to the first embodiment. However, the re-liquefying method according to the second embodiment is different from the re-liquefying method according to the first embodiment in a flow of the third sub stream after the separation for the third sub stream. For reference, parts, which are the same as (or correspond to) the previously-described parts, are denoted by the same (or corresponding) reference numerals, and a detailed description thereof will be omitted.

Referring to FIG. 4, the third sub stream is not introduced into the second heat exchange region 162 and is introduced into the separation member 202 after the separation for the third sub stream in the re-liquefying method according to the second embodiment. In this case, the simplicity in operation of the re-liquefying method can be further improved. That is, the re-liquefying method can be more efficiently controlled. This is because an amount of a stream to be separated into the fifth sub stream and the sixth sub stream at the separation member 202 can be more efficiently determined. The amount of the stream to be separated may be determined through liquid level control at the separation member 202.

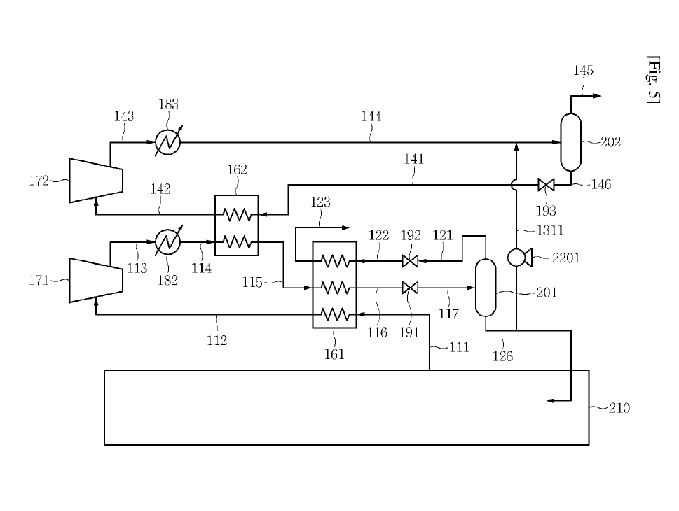

The re-liquefying method illustrated in FIG. 4 may be changed to a re-liquefying method illustrated in FIG. 5. FIG. 5 is a flow diagram illustrating a first modification of the re-liquefying method of FIG. 4. In the re-liquefying method according to the first modification, the third sub stream is forcibly transferred by a pump 2201 between the second separation operation and the first cooling operation. That is, referring to FIG. 5, the third sub stream is not naturally introduced into the cooling loop and is forcibly introduced thereinto by the pump 2201.

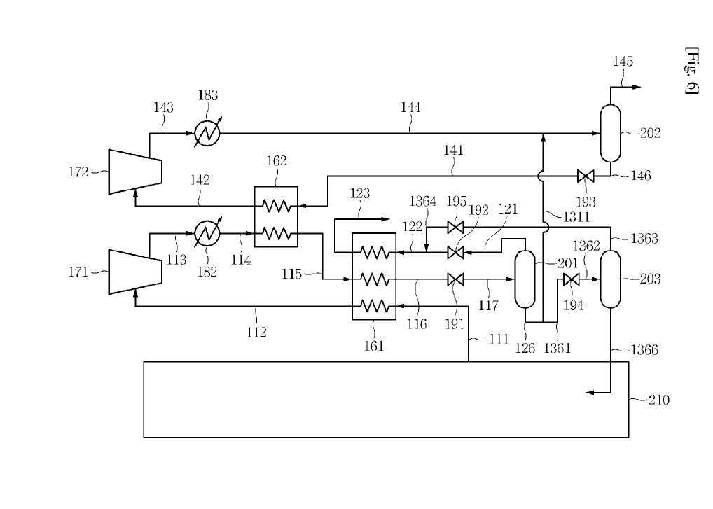

The re-liquefying method illustrated in FIG. 4 may also be changed to a re-liquefying method illustrated in FIG. 6. FIG. 6 is a flow diagram illustrating a second modification of the re-liquefying method of FIG. 4. In the re-liquefying method according to the second modification, a portion of the fourth sub stream is used for cooling the main stream, instead of just storing the fourth sub stream, thereby improving the process efficiency. In addition, a pump is not used in the re-liquefying method according to the second modification. This is described in detail in the re-liquefying method illustrated in FIG. 3.

1. A re-liquefying method for a liquid liquefied from a vapor, in which a main stream evaporated from a storage tank storing the liquid is re-liquefied, the method comprising:
a first introduction operation in which the main stream is introduced into a first heat exchange region;
a first compression operation in which the main stream is compressed after the first introduction operation;
a second introduction operation in which the main stream is introduced into a second heat exchange region after the first compression operation;
a third introduction operation in which the main stream is re-introduced into the first heat exchange region after the second introduction operation;
a first separation operation in which the main stream is separated into a first sub stream as a vapor and a second sub stream as a liquid after the third introduction operation;
a fourth introduction operation in which the first sub stream is introduced into the first heat exchange region;
a second separation operation in which the second sub stream is separated into a third sub stream and a fourth sub stream;
a first cooling operation in which the main stream is cooled in the second heat exchange region by using the third sub stream; and
a storage operation in which at least one portion of the fourth sub stream is stored in the storage tank.

2. The re-liquefying method of claim 1, further comprising a second cooling operation in which the main stream is cooled between the first compression operation and the second introduction operation.

3. The re-liquefying method of claim 1, further comprising a first expansion operation in which the main stream is expanded between the third introduction operation and the first separation operation.

4. The re-liquefying method of claim 1, further comprising a second expansion operation in which the first sub stream is expanded between the first separation operation and the fourth introduction operation.

5. The re-liquefying method of claim 1, wherein the first cooling operation comprises a fifth introduction operation in which the third sub stream is introduced into the second heat exchange region,
a second compression operation in which the third sub stream is compressed,
a third cooling operation in which the third sub stream is cooled,
a third separation operation in which the third sub stream is separated into a fifth sub stream as a vapor and a sixth sub stream as a liquid,
a third expansion operation in which the sixth sub stream is expanded, and
a first mixing operation in which the sixth sub stream is mixed with the third sub stream to be introduced into the second heat exchange region through the fifth introduction operation.

6. The re-liquefying method of claim 1, wherein the first cooling operation comprises a third separation operation in which the third sub stream is separated into a fifth sub stream as a vapor and a sixth sub stream as a liquid,
a third expansion operation in which the sixth sub stream is expanded,
a fifth introduction operation in which the sixth sub stream is introduced into the second heat exchange region,
a second compression operation in which the sixth sub stream is compressed,
a third cooling operation in which the sixth sub stream is cooled, and
a first mixing operation in which the sixth sub stream is mixed with the third sub stream to be passed through the third separation operation.

7. The re-liquefying method of claim 5, further comprising a fourth expansion operation in which the fourth sub stream is expanded,
a fourth separation operation in which the fourth sub stream is separated into a seventh sub stream as a vapor and an eighth sub stream as a liquid,
a fifth expansion operation in which the seventh sub stream is expanded, and
a second mixing operation in which the seventh sub stream is mixed with the first sub stream to be introduced into the first heat exchange region through the fourth introduction operation,
wherein the eighth sub stream is stored in the storage tank in the storage operation.

8. The re-liquefying method of claim 6, further comprising a fourth expansion operation in which the fourth sub stream is expanded,
a fourth separation operation in which the fourth sub stream is separated into a seventh sub stream as a vapor and an eighth sub stream as a liquid,
a fifth expansion operation in which the seventh sub stream is expanded, and
a second mixing operation in which the seventh sub stream is mixed with the first sub stream to be introduced into the first heat exchange region through the fourth introduction operation,
wherein the eighth sub stream is stored in the storage tank in the storage operation.

9. The re-liquefying method of claim 1, further comprising a forcible transfer operation between the second separation operation and the first cooling operation, wherein the third sub stream is forcibly transferred by a pump in the forcible transfer operation.
